(19) United States
(12) Patent Application Publication
(10) Pub. No.: US 2025/0348372 A1
(43) Pub. Date: Nov. 13, 2025

(54) MACHINE LEARNING PAIRING OF LOG EVENTS AND CODE

(71) Applicant: International Business Machines Corporation, Armonk, NY (US)

(72) Inventors: Mary Diane Swift, Rochester, NY (US); Saswati Dana, Bangalore (IN); Jonathan D. Dunne, Dungarvan (IR)

(21) Appl. No.: 18/660,122

(22) Filed: May 9, 2024

(51) Int. Cl. G06F 11/07; G06F 8/65; G06F 8/75; G06F 11/36; G06F 16/35

(52) U.S. Cl. CPC G06F 11/0766; G06F 8/65; G06F 8/75; G06F 11/3604; G06F 16/35

(57) ABSTRACT

Access to log event data and corresponding source code is obtained and static code analysis is performed on the source code to produce analysis output. First vectors representing the log event data and second vectors representing the analysis output are generated. A similarity analysis is performed on the first vectors and the second vectors. A probabilistic relevance score associating a given log event with a segment of the source code is determined based on the similarity analysis. A visualization is generated for log events based on the probabilistic relevance score.

### BACKGROUND

The present invention relates generally to the electrical, electronic and computer arts and, more particularly, to computer-aided software design and development.

During the design, development, testing and deployment of software, various events encountered while executing the software are typically memorialized in a log file. The events are usually presented in the log file in a chronological order (i.e., first-in, first-out (FIFO)). When reviewing the log events as part of a debugging process, however, there are many challenges in reviewing log files that are in chronological order. For example, if an error log event appears on a distinct line of the log file, a software developer or operations person often needs to look at the preceding log lines to infer if the log events are related.

### BRIEF SUMMARY

Principles of the invention provide techniques for search, analysis, arrangement and provisioning of log event data for software design and development. In one aspect, an exemplary method includes the operations of obtaining access to log event data and corresponding source code; performing static code analysis on the source code to produce analysis output; generating first vectors representing the log event data and second vectors representing the analysis output; performing a similarity analysis on the first vectors and the second vectors; determining a probabilistic relevance score associating a given log event with a segment of the source code based on the similarity analysis; and generating a visualization for log events based on the probabilistic relevance score.

In one aspect, a computer program product comprises a set of one or more computer-readable storage media and program instructions, collectively stored in the set of one or more storage media, the program instructions executable by a processor to cause the processor to perform computer operations comprising obtaining access to log event data and corresponding source code; performing static code analysis on the source code to produce analysis output; generating first vectors representing the log event data and second vectors representing the analysis output; performing a similarity analysis on the first vectors and the second vectors; determining a probabilistic relevance score associating a given log event with a segment of the source code based on the similarity analysis; and generating a visualization for log events based on the probabilistic relevance score.

In one aspect, a computer system comprises a processor set; a set of one or more computer-readable storage media; and program instructions, collectively stored in the set of one or more storage media, the program instructions executable by the processor set to cause the processor set to perform computer operations comprising obtaining access to log event data and corresponding source code; performing static code analysis on the source code to produce analysis output; generating first vectors representing the log event data and second vectors representing the analysis output; performing a similarity analysis on the first vectors and the second vectors; determining a probabilistic relevance score associating a given log event with a segment of the source code based on the similarity analysis; and generating a visualization for log events based on the probabilistic relevance score.

As used herein, “facilitating” an action includes performing the action, making the action easier, helping to carry the action out, or causing the action to be performed. Thus, by way of example and not limitation, instructions executing on a processor might facilitate an action carried out by instructions executing on a remote processor, by sending appropriate data or commands to cause or aid the action to be performed. Where an actor facilitates an action by other than performing the action, the action is nevertheless performed by some entity or combination of entities.

Techniques as disclosed herein can provide substantial beneficial technical effects. Some embodiments may not have these potential advantages and these potential advantages are not necessarily required of all embodiments. By way of example only and without limitation, one or more embodiments may provide one or more of:
a hierarchical model for analyzing and presenting log events in conjunction with the corresponding source code;
a user-definable visualization for examining log events and their corresponding source code;
log event clustering;
mapping of log events to the corresponding segment(s) of source code;
improvements to the ability to highlight software log events as dependent or independent;
improvements to the technological process of computer-aided software engineering (CASE) by improving an efficiency of software debugging and problem determination;
detection of software issues, such as detecting if software code is performing a greedy query on a database table;
prediction of an occurrence of a software error based on a pattern in software log events;
identifying and mitigating software bugs that degrade, over time, the performance of a software system; and
elimination of the requirement for a user to manually tag log events and, in the case of k-modes clustering, elimination of the need to know the number of centroids (i.e., the categorical location to cluster events) beforehand, thereby providing higher fidelity results and eliminating tedious tasks.

These and other features and advantages will become apparent from the following detailed description of illustrative embodiments thereof, which is to be read in connection with the accompanying drawings.

### BRIEF DESCRIPTION OF THE DRAWINGS

The following drawings are presented by way of example only and without limitation, wherein like reference numerals (when used) indicate corresponding elements throughout the several views, and wherein:

FIGS. 1A-1D illustrate an example workflow for the searching, analyzing, arranging and provisioning of log events, in accordance with an example embodiment;

FIGS. 2A-2D illustrate an example workflow for generating a Hierarchal Log Event Arrangement (HLEA) model and visualizing log events for source code, in accordance with an example embodiment;

FIG. 3 is an example visualization of the relationship between the log events and the source code, in accordance with an example embodiment;

FIG. 4 is a flowchart for an example method for searching, analyzing, arranging and provisioning of log events for source code, in accordance with an example embodiment; and

FIG. 5 depicts a computing environment according to an embodiment of the present invention.

It is to be appreciated that elements in the figures are illustrated for simplicity and clarity. Common but well-understood elements that may be useful or necessary in a commercially feasible embodiment may not be shown in order to facilitate a less hindered view of the illustrated embodiments.

### DETAILED DESCRIPTION

Principles of inventions described herein will be in the context of illustrative embodiments. Moreover, it will become apparent to those skilled in the art given the teachings herein that numerous modifications can be made to the embodiments shown that are within the scope of the claims. That is, no limitations with respect to the embodiments shown and described herein are intended or should be inferred.

Generally, techniques are provided for the searching, analyzing, arranging and provisioning of log events. In one example embodiment, the log events are automatically clustered for analysis and display. The log events and corresponding source code are rendered and displayed, based on the analysis, in an intuitive and easily consumable way for problem determination and problem mitigation. The disclosed methods have application across diverse source code languages (language-agnostic), software and service types, diverse domains (domain-agnostic) and the like.

As noted above, log events are typically presented in a log file in a chronological order. When reviewing log events as part of a debugging process, there are many challenges in reviewing log files in a chronological order as opposed to a more intuitive and easily consumable manner. It is noted that existing solutions allow a user to manually tag events, a time-consuming and error-prone task. Example embodiments eliminate the requirement for a user to manually tag log events and, in the case of k-modes clustering, eliminate the need to know the number of centroids (i.e., the categorical location to cluster events) beforehand, thereby providing higher fidelity results and eliminating tedious tasks.

### Arranging Log Events in an Intuitive Way

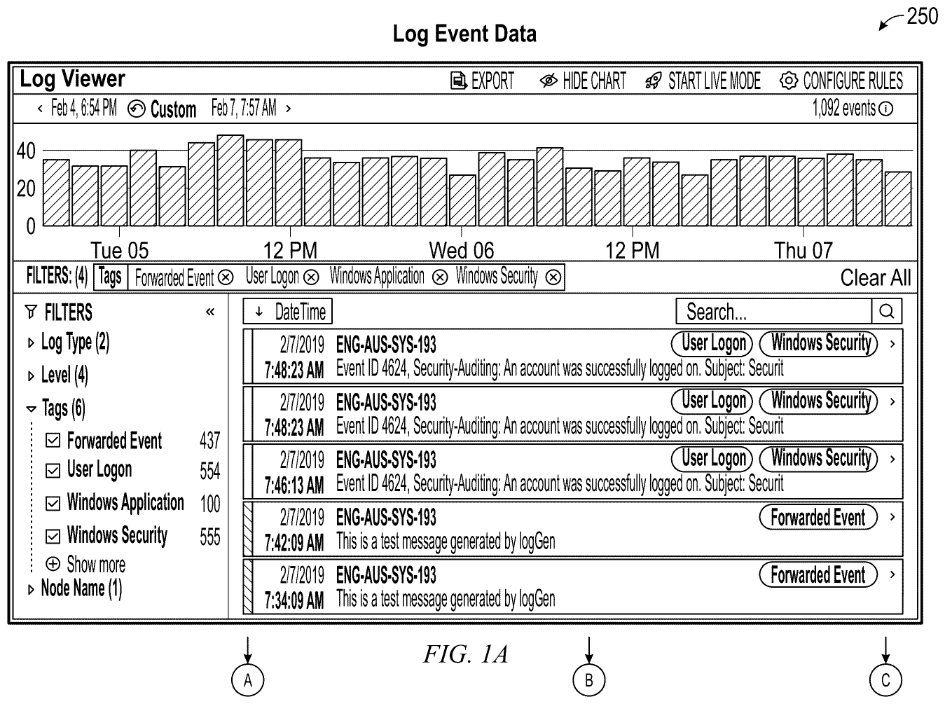

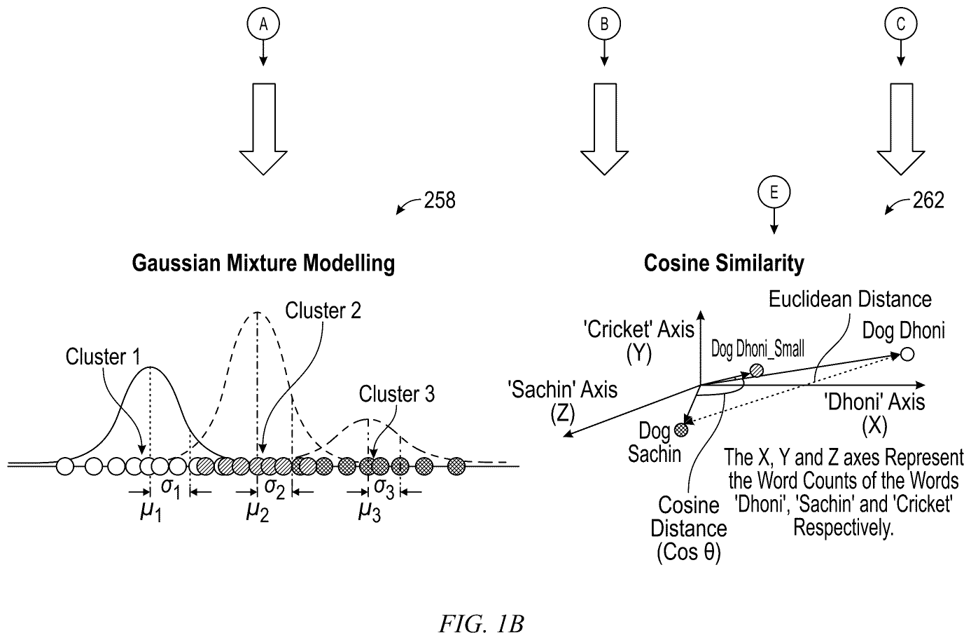

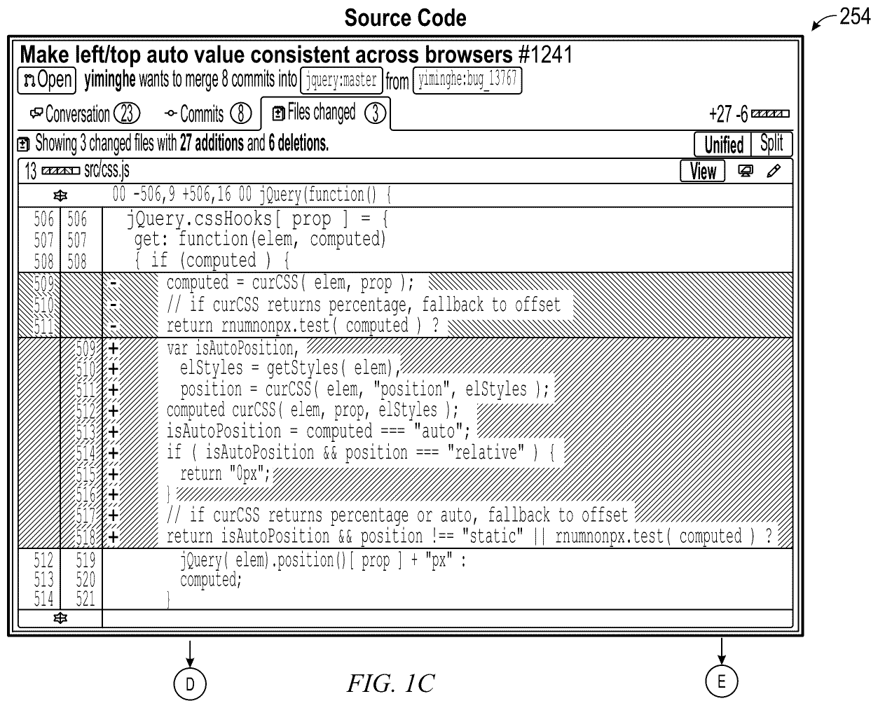

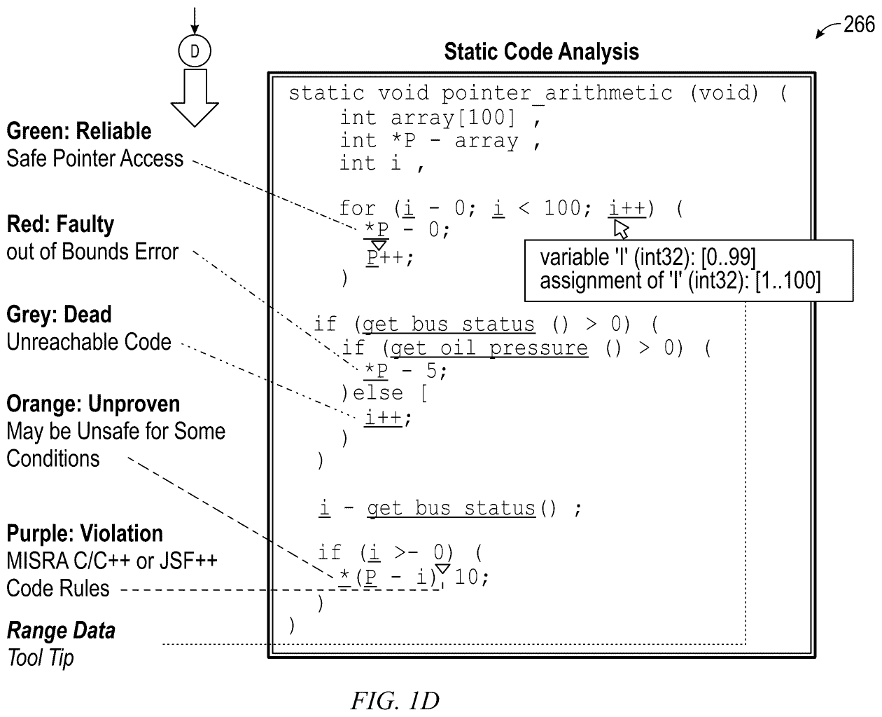

FIGS. 1A-1D illustrate an example workflow for the searching, analyzing, arranging and provisioning of log events, in accordance with an example embodiment. Log events 250 (also referred to as “log events data” herein) are the result of executing source code 254 and are often arranged in a chronological order. Log events that are generated by executing source code 254 are parsed to generate a set of log events 250 in a logical order. The log events 250 can be grouped broadly by type (such as error event, warning event, artifact and/or the like) or more narrowly, for example, by type of error, type of warning, type of artifact and/or the like. Type of artifact can include, for example, all log events 250 related to a specific collection (such as a grouping of similar types of events, including a database query, a hanging thread, a timed-out job queue and the like), a specific customer, a correlation identifier (such as a pairwise matching of multiple log events as a dependent sequence or a chain of a problem or issue) and the like. In some embodiments, code includes a printf statement (Java or C/C++ programming language terminology) that will produce a statement that shows up in the log event data. Aspects of the invention are based on a concept that such log event data provides a symbolic link to a log code output, e.g., to a function of the code. In some embodiments, a log code statement is a concatenation of multiple print statements from multiple code blocks. As mentioned above, a code block will perform some type of operation and that code block will also contain some form of print statement that will output a message fragment to a log file as part of the log event data. Distributed applications typically contain tasks that provide operations from multiple systems in series. Therefore, in some embodiments, a log message that is part of the log event data is a concatenation of log messages from multiple heterogeneous systems.

Below is an excerpt of source code which shows how a print statement could generate log event data which could provide information about code output.
def calculate_area(x_coords, y_coords):
   n=len(x_coords)
      #Ensure the number of x and y coordinates match
   if n!=len(y_coords):
      raise ValueError(“Number of x and y coordinates must be the same”)
   #Apply the shoelace formula
   area=0.5*abs(sum(x_coords[i] *y_coords[(i+1) % n]−y_coords[i]*x_coords[(i+1) % n] for i in range (n)))
   return area
#Example coordinates
x_coordinates=[1, 1, 2, 2]
y_coordinates=[0, 21.404241, 27.627941, 12.852979]
#Calculate the area
quad_area=calculate_area(x_coordinates, y_coordinates)
#Print the result
print(f“The area of the quadrilateral is: {quad_area}”)

In one example embodiment, source code 254 is analyzed using static code analysis 266. Conventional static code analysis extracts entities from the source code 254, such as function calls, keywords and the like, and ascertains, at each level of the code compartments, or distinct files or class, the activity that is being performed. Various static code analysis tools are applied in various embodiments to perform the static code analysis of the source code, e.g., of the source code that is input into a machine learning model. Such static code analysis tools include, but are not limited to, linters, bug finders, type checkers, duplicate code detectors, dependency checkers, complexity analyzers, and security scanners. Concerning the sample code mentioned above, the static code analysis 266 on this sample code would produce an output indicating that a function of “mathematical calculation” is being performed with that source code block. In some embodiments, the static code analysis 266 also identifies functions of smaller code block segments, for example, the functions could be declarations, if-then statements, summations, print statements, and the like.

In one example embodiment, the log events 250 are analyzed using cluster analysis and similarity analysis. The clustering may be performed, for example, using a Gaussian Mixture Model (GMM) 258 which enables the clustering of the log event data 250 to be performed without the need for supervised learning. As noted above, the clustering may be performed based on the type of log event 250. The clustering, in some embodiments, identifies clusters of vectors representing the log event data and/or the log events. In some embodiments, each cluster has a respective centroid unigram, bi-gram and/or n-gram used to group similar log events. Certain log events that occur are often related to a particular component or action. A particular component or action could have many error messages or many warning messages. Looking at various different pieces of texts of log event data, the pieces may relate to a particular component/action. Clustering the log event data allows grouping of log events related to similarity, such as having a cluster related to database type warning messages, a cluster related to a web server, a cluster related to a queuing system, a cluster related to indexing, a cluster related to a database, a cluster related to an application processing interface (API) gateway, a cluster related to a web server, and the like. By using a clustering algorithm, such as a Gaussian mixture model that applies an unsupervised training technique, training data is not required in advance to train the HLEA model. The model gathers and builds its data frame as it begins its task to analyze the log event data and source code.

In one example embodiment, the similarity analysis 262 is performed using cosine similarity between vectors representing the log event data 250 and vectors representing the source code 254 to identify the source code 254 that corresponds to each log event 250. In one example embodiment, details of the log event 250 are maintained for visualization and display to the user. In some embodiments, vectors representing text that is the output of the static code analysis of the source code, e.g., a function of the source code, are compared with vectors representing text describing a respective centroid (e.g., unigram) of the log event data/vectors to determine the similarity.

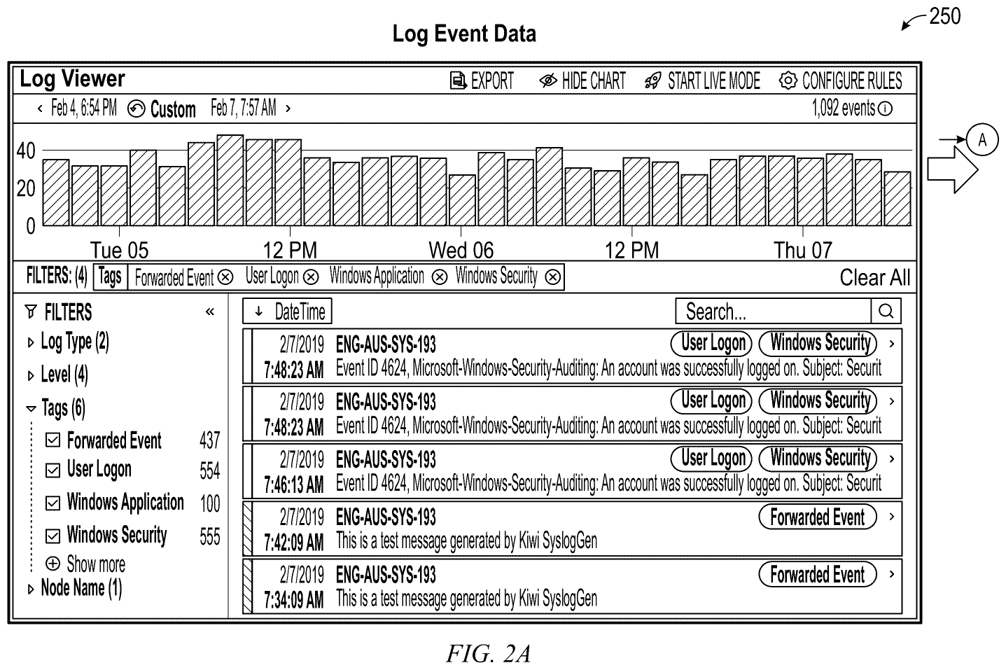

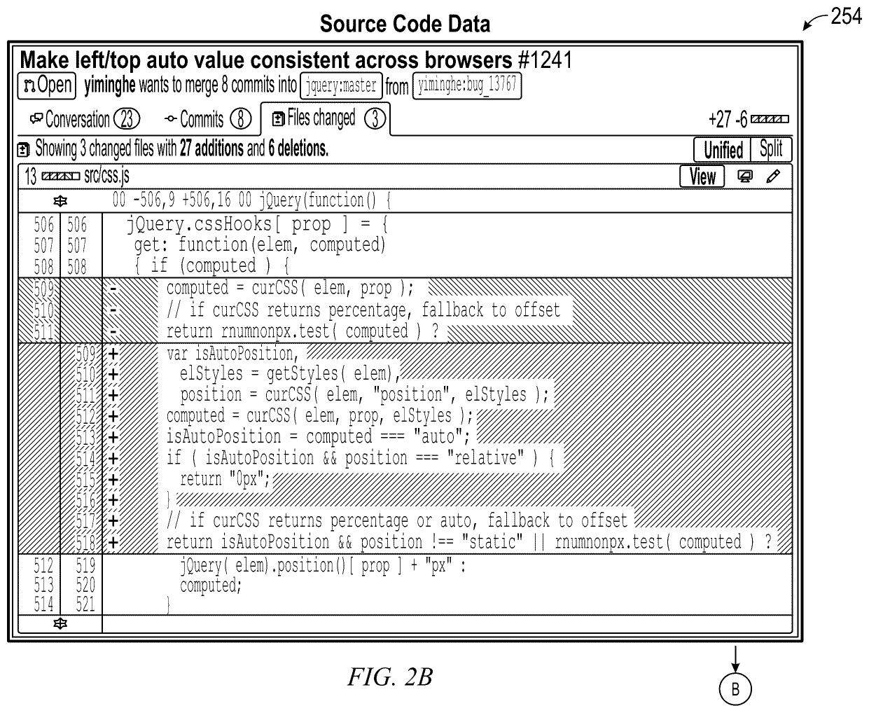

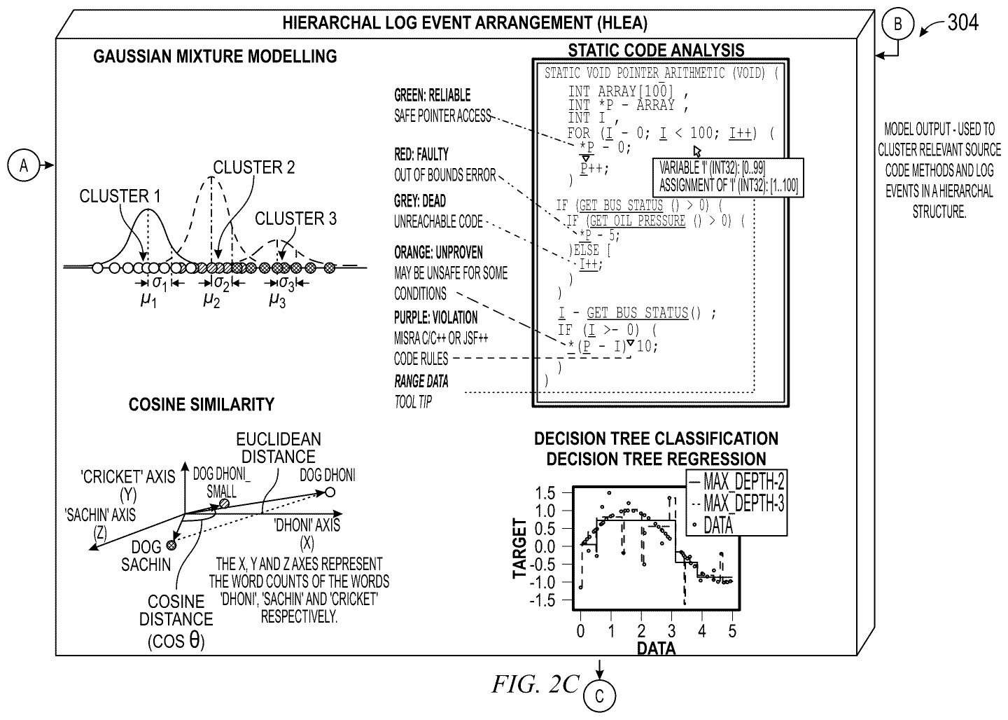

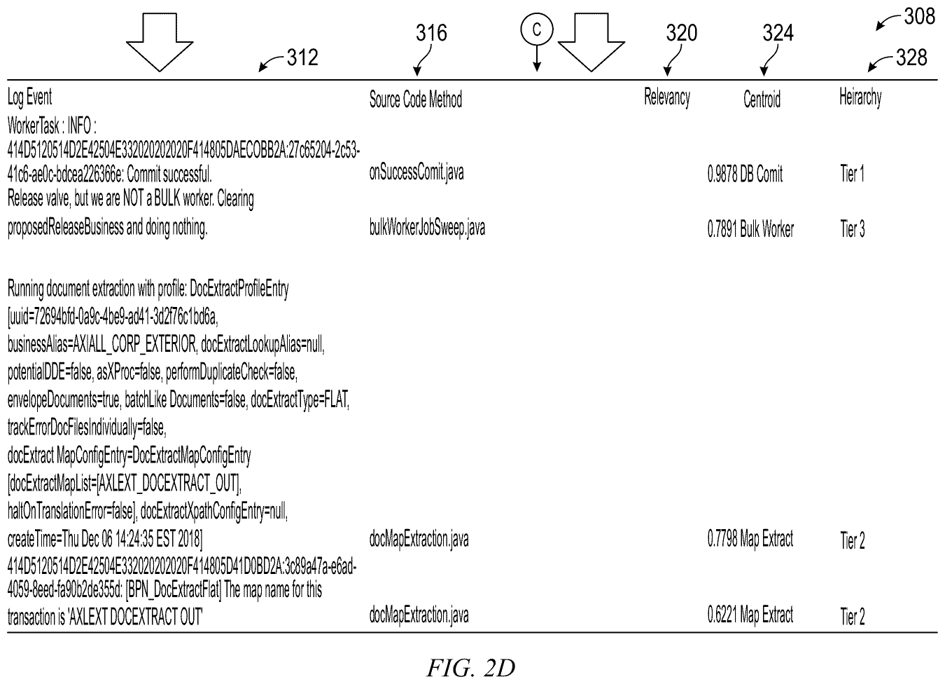

FIGS. 2A-2D illustrate an example workflow for generating a Hierarchal Log Event Arrangement (HLEA) model 304 and visualizing log events 250 for source code 254, in accordance with an example embodiment. In one example embodiment, a Hierarchal Log Event Arrangement (HLEA) model 304 is derived from the results of the cluster analysis (e.g., produced via the Gaussian Mixture Model (GMM) 258), the similarity analysis (e.g., the cosine similarity analysis 262) of the log events 250 and the results of the static code analysis 266. The Hierarchal Log Event Arrangement (HLEA) model 304 is then used to build a visualization, such as a data frame 308, that visualizes the log events 250, the source code 254 and the like. In at least some embodiments, the visualization, e.g., data frame 308, constitutes a collection object that is accessed and/or consulted, for example, to troubleshoot the cause of log event exceptions and the like. The HLEA model 304 includes one or more machine learning model components that perform cluster analysis, machine learning textual similarity analysis, and classification. The HLEA model 304, in some embodiments, includes embedding layers to generate vectors, e.g., embeddings, from textual words (e.g., log event data and/or text output from a static code analysis of software code) that are input into the HLEA model 304. The machine learning model(s) analyze vectors generated from the textual input to perform the cluster analysis and machine learning textual similarity analysis. In some embodiments, the HLEA model 304 includes a language machine learning model, such as a large language model, in order to perform the textual similarity analysis. Such a language machine learning model is pretrained on a large variety of text in order to learn to understand nuances of the particular language of the training text and to learn to be able to predict and/or generate text related to an input request. The HLEA model 304, in some embodiments, includes other software code to perform other features, such as the static code analysis and a hierarchical visualization of log event data. The machine learning model components for performing the classification, such as determining a probabilistic relevance score that maps a given log event to a given compartment of source code, are in some embodiments in a form of support vector machines, neural networks, logic-centric production systems, naïve Bayesian belief networks, fuzzy logic, random forest trees, gradient-boosted decision trees, and/or data fusion engines. Other types of machine learning models/components are implemented in the HLEA model 304 for the HLEA model 304 to perform classification.

The HLEA model 204 uses base tabular data, such as a data frame as a quadruple, a csv, and/or nested data (e.g., in a JSON format) to generate a visualization that is displayed in at least some embodiments. In at least some embodiments, the data frame is a data structure that organizes data into a two-dimensional table of rows and columns, e.g., a spreadsheet. In one example embodiment, the visualization includes a hierarchical view of the log event data 250. The hierarchical view is, for example, displayed by the tabular data frame 308. In the hierarchical view, main file types are arranged in a hierarchical order with subclasses of files that relate to a parent class. The log events 250 can be displayed based on a rank of the relevance of each log event 250 relative to its position in a code compartment (based, for example, on a relevancy score), based on a rank of the importance of the source code 254 (where each code compartment is assigned a corresponding tier level that indicates the importance level of the code segment), based on a rank of the importance of the event and the like. For example, portions of the source code 254 that are directed to writing to a database will be mapped to a higher tier than the portions of the source code 254 that implement a reporting tool, because the task of writing to a database is understood as being more important than the reporting tool with regard to the overall purpose of the code. In some embodiments, the data frame 308 captures a hierarchy of importance of code based on the level of the problem that is generated when a code block contains an error, e.g., based on position importance of individual who is notified when an error in the particular code block appears.

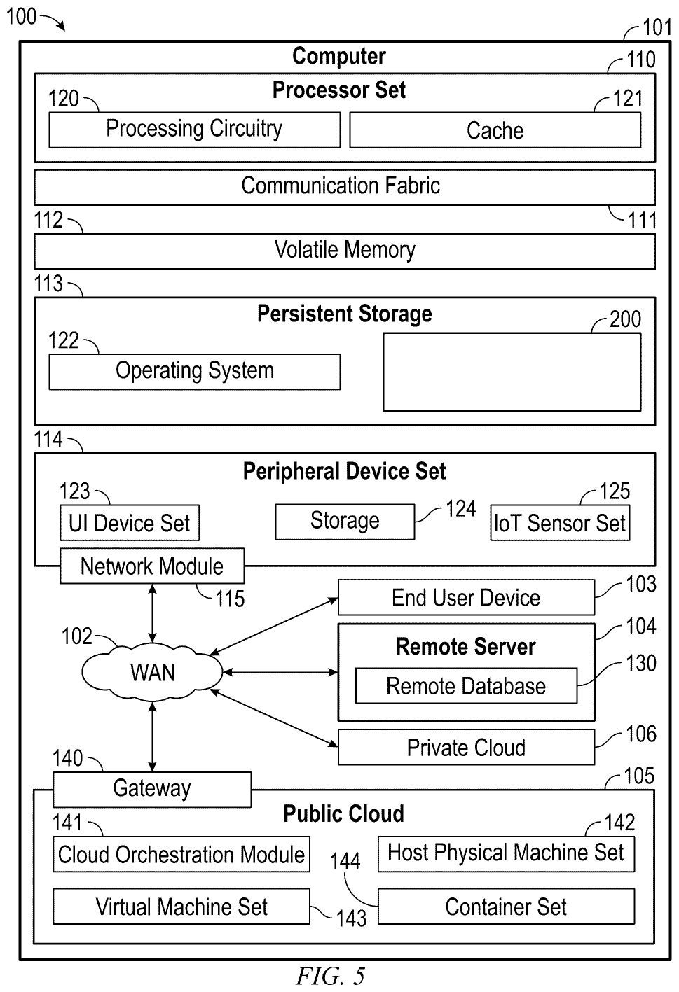

An occurrence of an error (event) based on a previous pattern in the log file is predicted via the code 200 automatically (explained below with respect to FIG. 5). For example, if it is known that an event B is dependent on an event A, the frequency that event B happens given event A (e.g. P(B|A)) can be modelled and the code 200 automatically computes this calculation using conditional probability. The system performs structuring of the log events 250 uniformly or canonically. (As used herein, structured uniformly refers to the operation of arranging events in a uniform manner (such as by frequency or alphabetically) and canonically refers to assembling a framework of known event types of a specific order and adding event frequencies within that framework as a form or predefined schema.) For example, the conditional probability indicates a probability that source code blocks each relate to a bulk worker and/or node of a computing environment.

In one example embodiment, each row of the tabular data frame 308 has a method name 316, an associated log event description 312, a corresponding similarity score (relevance score) 320 based on the similarity analysis 262 and a designated centroid ID 324. The HLEA model 304 derives the hierarchy level 328 from the location of the method within the source code compartment and the importance of the source code compartment.

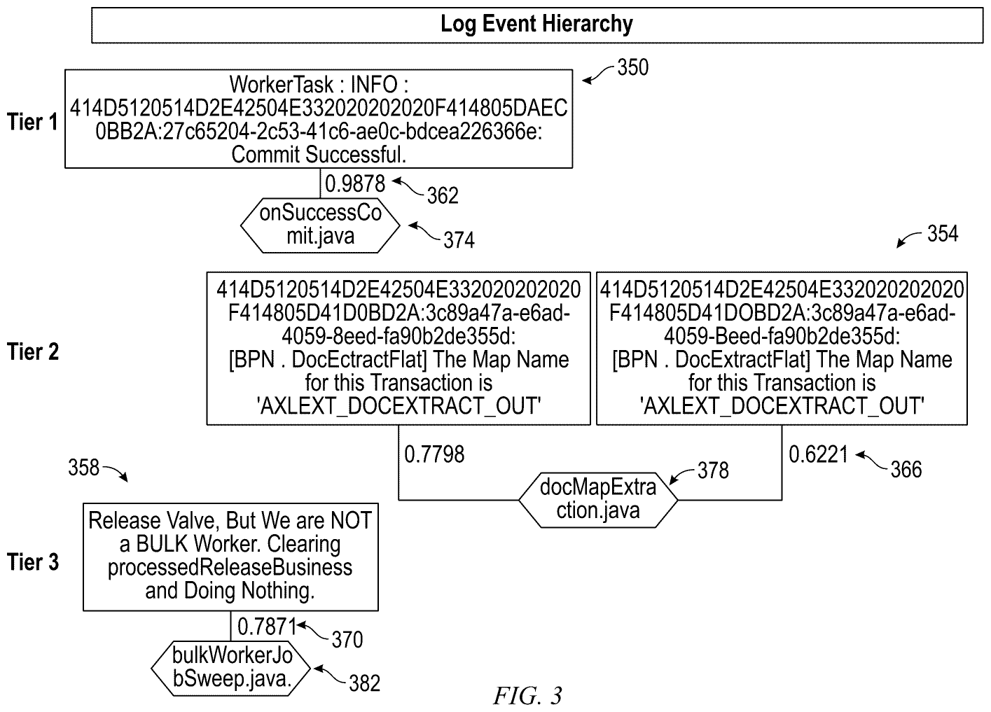

FIG. 3 is an example visualization of the relationship between the log events 250 and the source code 254, in accordance with an example embodiment. In some embodiments, the code 200 and/or the HLEA model 304 automatically generates and displays the visualization shown in FIG. 3 based on receiving log event data and codes and/or based on receiving a data frame, such as the data frame 308 shown in FIG. 2D. In some embodiments, this code for the hierarchical visualization is not machine learning code, but instead is software development code for creating a graphical visualization. As illustrated in FIG. 3, an identifier 374, 378, 382 (such as a method name) of each segment of source code 254 is displayed based on a corresponding tier level of the segment of source code 254. For example, the tier level may represent the importance of the segment of source code 254, where a lower tier level indicates a relatively more important segment of source code 254 and a higher tier level indicates a relatively less important segment of source code 254. Each segment of source code 254 is linked with one or more descriptions 350, 354, 358 of log events 250, where the linked log events(s) 250 has been determined to be caused by execution of the corresponding segment of source code 254. The links 362, 366, 370 are annotated with an indication of the level of relevance of the description 350, 354, 358 of the log event 250 to the corresponding segment of source code 254.

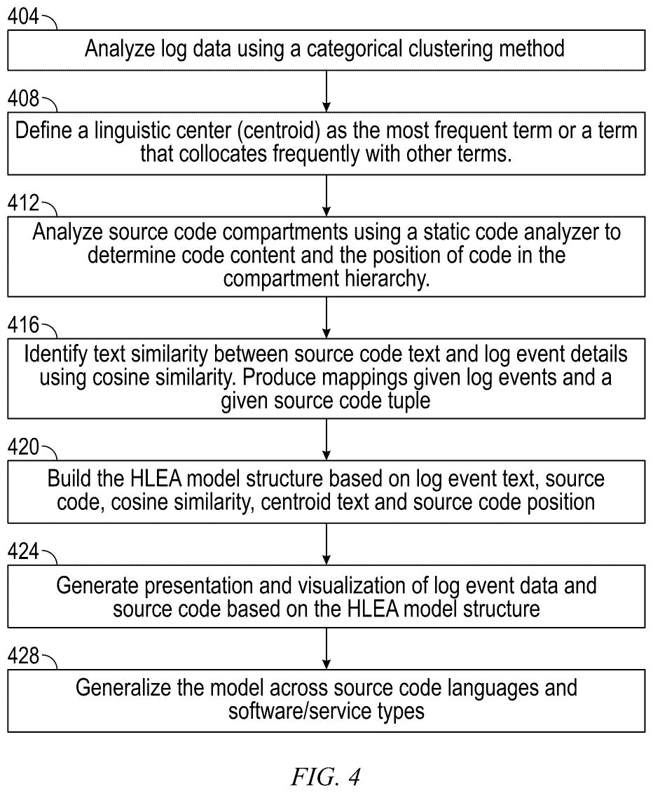

FIG. 4 is a flowchart for an example method for searching, analyzing, arranging and provisioning of log events 250 for source code 254, in accordance with an example embodiment. In one example embodiment, the log event data 250 is analyzed using a categorical cluster method (operation 404). As noted above, the clustering can be performed using, for example, a Gaussian Mixture Model (GMM) which enables the unsupervised clustering of the log event data 250. The clustering can be performed, for example, based on log event types. In one example embodiment, the clustering includes K-Modes clustering. A linguistic center (centroid) is derived based on, for example, the most frequent term in the log events 250, a term that collocates with other terms in the log events 250, and the like (operation 408). The outputs of the analysis include the formation of a series of clusters, each with a centroid label and location on a Cartesian plane (x, y coordinates).

Source code compartments are analyzed using a static code analyzer to determine the content of the source code and the position of the source code in the compartment hierarchy (operation 412). As noted above, static code analysis extracts entities from the source code 254, such as function calls, keywords and the like, and ascertains, at each level of the code compartments (or distinct files or class), the activity that is being performed. For example, a casting from one variable type to another, a count of declarations, types of functions and the like may be ascertained.

Text similarity between the text of the source code 254 and details of the log event data 250 is identified using cosine similarity to produce cosine similarity 262, including relevance scores that indicate a relevance between the details of the log event 250 and the source code 254. Cosine analysis provides a distance measurement and an angle which is used to infer similarity. The comparison of a log event 250 and, for example, code method names is output as a probabilistic score between 0 and 1. A mapping of a given log event 250 and a given compartment of the source code 254 is produced based on the probabilistic relevance score (operation 416).

A Hierarchal Log Event Arrangement (HLEA) model 304 is generated based on the analysis of the log event data 250 and the source code 254 (operation 420). For example, the results of the static code analysis and log event data 250 are used to model the relationship between the classes/methods of the source code 254 that invoke distinct log events 250. The HLEA model 304 is used to arrange log events 250 for presentation and visualization, such as via the tabular data frame 308 (operation 424). The presentation and visualization of log events 250 may be ranked based on system and/or user preferences. For example, the rankings can be used to highlight high ranking events, such as events related to tasks that amend database data, and/or omit low ranking events, such as events related to tasks that generate basic reports. In one example embodiment, the presentation and visualization are rendered in a log analysis/aggregation tool.

The HLEA model 304 is generalized across source code languages, software/service types and the like (operation 428). In one example embodiment, transfer learning is used to transfer knowledge to and bootstrap models for other source code languages and software/service types. For example, a machine learning model based on tuples or collection classes for financial data related to a financial application may be used to provide transfer knowledge in training a model for another financial application that uses a similar tuple or collection class. In general, a model based on tuples or collection classes may be used to provide transfer knowledge in training a model for another application that uses a similar source language for a similar domain.

Given the discussion thus far, it will be appreciated that, in general terms, an exemplary method, according to an aspect of the invention, includes the operations of obtaining access to log event data 250 and corresponding source code 254; performing static code analysis on the source code 254 to produce analysis output (operation 412); generating first vectors representing the log event data 250 and second vectors representing the analysis output (operation 404); performing a similarity analysis on the vectors and the second vectors; determining a probabilistic relevance score associating a log event 250 with a segment of the source code 254 based on the similarity analysis; and generating a visualization for the log events 250 based on the probabilistic relevance score (operation 424).

In one aspect, a computer program product comprises a set of one or more computer-readable storage media and program instructions, collectively stored in the set of one or more storage media, the program instructions executable by a processor to cause the processor to perform computer operations comprising obtaining access to log event data 250 and corresponding source code 254; performing static code analysis on the source code 254 to produce analysis output (operation 412); generating first vectors representing the log event data 250 and second vectors representing the analysis output (operation 404); performing a similarity analysis on the vectors and the second vectors; determining a probabilistic relevance score associating a log event 250 with a segment of the source code 254 based on the similarity analysis; and generating a visualization for the log events 250 based on the probabilistic relevance score (operation 424).

In one aspect, a computer system comprises a processor set; a set of one or more computer-readable storage media; and program instructions, collectively stored in the set of one or more storage media, the program instructions executable by the processor set to cause the processor set to perform computer operations comprising obtaining access to log event data 250 and corresponding source code 254; performing static code analysis on the source code 254 to produce analysis output (operation 412); generating first vectors representing the log event data 250 and second vectors representing the analysis output (operation 404); performing a similarity analysis on the vectors and the second vectors; determining a probabilistic relevance score associating a log event 250 with a segment of the source code 254 based on the similarity analysis; and generating a visualization for the log events 250 based on the probabilistic relevance score (operation 424).

In one example embodiment, a clustering algorithm is applied to the first vectors to determine a similarity between the first vectors and to identify clusters of log events 250, wherein the similarity analysis on the first vectors and the second vectors uses vector representations of the clusters as the first vectors (operation 404).

In one example embodiment, the visualization comprises a data frame comprising a quadruple, wherein each line of the quadruple is for a respective log event 250 represented in the log event data and comprises: a method name, details of the respective log event 250, a relevance value indicating a similarity between a vector representing the respective log event 250 and another vector representing source code of the corresponding source code 254, and a centroid identifier for a respective cluster of the clusters, the respective cluster comprising the respective log event 250.

In one example embodiment, new data for a new log event 250 is received and the new data is compared to the data frame so that information about the new log event 250 is determined.

In one example embodiment, the information is selected from a group consisting of a prediction of a future occurrence of an event, a list of past log events that are similar to the new log event 250, and an identification of a function of the source code 254 that corresponds to the new log event.

In one example embodiment, the clustering algorithm is based on a Gaussian Mixture Model (GMM).

In one example embodiment, the visualization comprises a visual hierarchy of log events 250 that are represented by the log event data.

In one example embodiment, the analysis output comprises respective functions of source code blocks of the corresponding source code 254, and wherein the similarity analysis on the first vectors and the second vectors uses vector representations of the functions as the second vectors.

In one example embodiment, a relative importance of the source code blocks is determined based on the functions and respective positions of the source code blocks in a compartment hierarchy based on the relative importance.

In one example embodiment, a machine learning model is generated that, in response to receiving new log event data and new corresponding source code as input, generates a new visualization that models a relationship between the new log event data and the new corresponding source code.

In one example embodiment, the machine learning model is generalized across source code languages.

In one example embodiment, the machine learning model further generates a ranking of new log events 250 represented by the new log event data in response to receiving the input, wherein the ranking is based on one or more user preferences.

In one example embodiment, the similarity analysis includes a cosine similarity analysis.

In one example embodiment, the similarity analysis discovers similarities based on a type of log events 250.

In one example embodiment, a given log event 250 is mapped to a given compartment of the source code 254 based on the probabilistic relevance score.

In one example embodiment, an occurrence of an error is predicted based on a pattern in log events 250 that were represented by the log event data.

In one example embodiment, a software error is identified based on the visualization for the log events 250, a software component is rewritten to eliminate the software error and the rewritten software component is deployed.

In one example embodiment, a Hierarchal Log Event Arrangement (HLEA) model 304 that models a relationship between a given log event 250 and a given segment of the source code 254 that invoked the given log event 250 is generated based on the similarity analysis and the static code analysis (operation 420).

In one example embodiment, the HLEA model 304 is generalized across source code languages (operation 428).

In one example embodiment, the generating the visualization for the log events 250 further comprises generating a visual hierarchy of the log events 250 using the Hierarchal Log Event Arrangement (HLEA) model 304.

In one example embodiment, the log events 250 are ranked based on one or more user preferences and the Hierarchal Log Event Arrangement (HLEA) model 304.

In one example embodiment, the similarity analysis includes a cosine similarity analysis.

In one example embodiment, the visualization comprises a quadruple, the quadruple comprising, for at least one log event 250, a method name, details of the at least one log event 250, a relevance value indicating a similarity between the vectors of the at least one log event 250 and the source code 254, and a centroid identifier for a cluster generated by the clustering algorithm, the cluster comprising the at least one log event 250.

In one example embodiment, the similarity analysis discovers similarities based on a type of the log event 250.

In one example embodiment, the static code analysis identifies a function of at least one segment of the source code 254, the function being suitable for determining a relative importance of the at least one segment and a position of the at least one segment of the source code 254 in a compartment hierarchy.

In one example embodiment, the clustering algorithm is based on a Gaussian Mixture Model (GMM).

In one example embodiment, a given log event 250 is mapped to a given compartment of the source code 254 based on the probabilistic relevance score (operation 416).

In one example embodiment, data for a new log event is received, the data for the new log event is input into the data frame, and wherein the generating the visualization for the log events 250 further comprises extracting data from the data frame.

In one example embodiment, the extracted data is selected from a group consisting of a prediction of an occurrence of an event, a list of similar past log events, and an identification of a function of the source code 254 that corresponds to the new log event.

In one example embodiment, an occurrence of an error is predicted based on a pattern in the log events 250.

In one example embodiment, the predicting the occurrence of the error based on the pattern in the log events 250 is performed using machine learning or a Markov chain.

In one example embodiment, the log events 250 are structured in a uniform manner or the log events 250 are structured canonically by assembling a framework of known event types of a specific order and event frequencies are added within the framework as a form or predefined schema.

In one example embodiment, a software error is identified based on the visualization for the log events, a software component is rewritten to eliminate the software error and the rewritten software component is deployed. It will be appreciated that identifying the software error based on the visualization for the log events inherently and advantageously focuses in on the portion of the source code that caused the software error.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as computer-aided software design and development system 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 5. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and rewriting of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, the method comprising:
obtaining access to log event data and corresponding source code;
performing static code analysis on the source code to produce analysis output;
generating first vectors representing the log event data and second vectors representing the analysis output;
performing a similarity analysis on the first vectors and the second vectors;
determining a probabilistic relevance score associating a given log event with a segment of the source code based on the similarity analysis; and
generating a visualization for log events based on the probabilistic relevance score.

2. The method of claim 1, further comprising applying a clustering algorithm to the first vectors to determine a similarity between the first vectors and to identify clusters of log events, wherein the similarity analysis on the first vectors and the second vectors uses vector representations of the clusters as the first vectors.

3. The method of claim 2, wherein the visualization comprises a data frame comprising a quadruple, wherein each line of the quadruple is for a respective log event represented in the log event data and comprises:
a method name,
details of the respective log event,
a relevance value indicating a similarity between a vector representing the respective log event and another vector representing source code of the corresponding source code, and
a centroid identifier for a respective cluster of the clusters, the respective cluster comprising the respective log event.

4. The method of claim 3, further comprising receiving new data for a new log event and comparing the new data to the data frame so that information about the new log event is determined.

5. The method of claim 4, wherein the information is selected from a group consisting of a prediction of a future occurrence of an event, a list of past log events that are similar to the new log event, and an identification of a function of the source code that corresponds to the new log event.

6. The method of claim 2, wherein the clustering algorithm is based on a Gaussian Mixture Model (GMM).

7. The method of claim 1, wherein the visualization comprises a visual hierarchy of log events that are represented by the log event data.

8. The method of claim 1, wherein the analysis output comprises respective functions of source code blocks of the corresponding source code, and wherein the similarity analysis on the first vectors and the second vectors uses vector representations of the functions as the second vectors.

9. The method of claim 8, further comprising determining a relative importance of the source code blocks based on the functions and respective positions of the source code blocks in a compartment hierarchy based on the relative importance.

10. The method of claim 1, further comprising generating a machine learning model that in response to receiving new log event data and new corresponding source code as input generates a new visualization that models a relationship between the new log event data and the new corresponding source code.

11. The method of claim 10, further comprising generalizing the machine learning model across source code languages.

12. The method of claim 10, wherein the machine learning model further generates a ranking of new log events represented by the new log event data in response to receiving the input, wherein the ranking is based on one or more user preferences.

13. The method of claim 1, wherein the similarity analysis includes a cosine similarity analysis.

14. The method of claim 1, wherein the similarity analysis discovers similarities based on a type of log events.

15. The method of claim 1, further comprising mapping a given log event to a given compartment of the source code based on the probabilistic relevance score.

16. The method of claim 1, further comprising predicting an occurrence of an error based on a pattern in log events that were represented by the log event data.

17. The method of claim 1, further comprising identifying a software error based on the visualization for the log events, rewriting a software component to eliminate the software error and deploying the rewritten software component.

18. A computer program product comprising:
a set of one or more computer-readable storage media; and
program instructions, collectively stored in the set of one or more storage media, the program instructions executable by a processor to cause the processor to perform computer operations comprising:
obtaining access to log event data and corresponding source code;
performing static code analysis on the source code to produce analysis output;
generating first vectors representing the log event data and second vectors representing the analysis output;
performing a similarity analysis on the first vectors and the second vectors;
determining a probabilistic relevance score associating a given log event with a segment of the source code based on the similarity analysis; and
generating a visualization for log events based on the probabilistic relevance score.

19. The computer program product of claim 18, wherein the computer operations further comprise applying a clustering algorithm to the first vectors to determine a similarity between the first vectors and to identify clusters of log events, wherein the similarity analysis on the first vectors and the second vectors uses vector representations of the clusters as the first vectors.

20. A computer system comprising:
a processor set;
a set of one or more computer-readable storage media; and
program instructions, collectively stored in the set of one or more storage media, the program instructions executable by the processor set to cause the processor set to perform computer operations comprising:
obtaining access to log event data and corresponding source code;
performing static code analysis on the source code;
generating vectors representing the log event data;
performing a clustering algorithm on the vectors to determine a similarity between the vectors and to identify clusters of the log events;
performing a similarity analysis on the vectors and the source code to determine a similarity between the vectors and the source code based on the static code analysis;
determining a probabilistic relevance score associating a given log event with a segment of the source code based on the similarity analysis; and
generating a visualization for the log events based on the probabilistic relevance score.
